(19) United States
(12) Patent Application Publication
(10) Pub. No.: US 2017/0047799 A1
(43) Pub. Date: Feb. 16, 2017

(54) PERMANENT MAGNET SYNCHRONOUS MOTOR AND A ROTOR THEREOF

(71) Applicant: UNITED AUTOMOTIVE ELECTRONIC SYSTEMS CO. LTD, Shanghai (CN)

(72) Inventors: Wenxiang HUANG, Shanghai (CN); Ming HAN, Shanghai (CN); Jie BAO, Shanghai (CN); Yongjin KONG, Shanghai (CN); Daqian JIANG, Shanghai (CN); Yihui CHEN, Shanghai (CN); Jia SHI, Shanghai (CN)

(73) Assignee: UNITED AUTOMOTIVE ELECTRONIC SYSTEMS CO. LTD, Shanghai (CN)

(21) Appl. No.: 15/306,568

(22) PCT Filed: Dec. 31, 2014
(86) PCT No.: PCT/CN2014/095792

§ 371 Date: Oct. 25, 2016

(30) Foreign Application Priority Data
Apr. 25, 2014 (CN) 201410168537.9

(51) Int. Cl. H02K 1/26; H02K 21/02

(52) U.S. Cl. CPC H02K 1/26; H02K 21/02

(57) ABSTRACT

A permanent magnet synchronous motor, a rotor thereof comprising an iron core in cylindrical form, with p S pole magnet plates and p N pole magnet plates arranged inside of the iron core around an axis thereof, wherein p is a positive integer, and the p S pole magnet plates and the p N pole magnet plates are alternatively aligned; on a surface of a rotor iron core of each magnet steel plate are arranged two d axial surface grooves; the two d axial surface grooves corresponding to each magnet steel plate are situated on two sides of a center line of the magnet steel plate; an inter-axial distance of the two d axial surface grooves of each magnet steel plates is approximately equal to a tooth tip span of a rotor tooth of the permanent magnet synchronous motor. Also disclosed is a rotor of a permanent magnet synchronous motor.

### FIELD OF INVENTION

The present invention relates to a motor, and relates in particular to a permanent magnet synchronous motor and a rotor thereof.

### BACKGROUND ART

A permanent magnet synchronous motor features high torque density, high power density, and a wide high efficiency area, and is a first choice of driving motors for new energy vehicles as hybrid, pure electric and fuel cell cars. Particularly for a permanent magnet synchronous motor with an interior permanent magnet, reluctance torque due to saliency effects of the rotor can be made use of to further increase its toque and expand its speed adjustable range, so as to increase its rotating speed. On the other hand, a permanent magnet rotor comes with it cogging torque, and in addition to the effects of nonlinear magnetic circuits due to magnetic saturation, it has rich back EMF harmonic content, thus its torque ripple under load condition is more serious than a common asynchronous motor or a permanent magnet motor with surface permanent magnet. All these further result in NVH (noise, vibration, harshness), which is a discomfort for passengers to be solved.

A solution of prior art in diminishing torque ripple by effectively reducing back EMF harmonic wave and cogging torque is to select a reasonable pole and slot combination. For example, majority of driving motors for vehicles as represented by Toyota Prius adopt a plan with 48 slots for the stator and 8 poles for the rotor, while ISG motors represented by Honda IMA adopt a plan of concentrated winding with a slot-pole ratio of 3:2.

FIG. 1 shows a permanent magnet synchronous motor with 48 slots and 8 poles for the Toyota Prius, which exhibits rich harmonic content in its back EMF waveform since neither the stator nor the rotor is skewed, as is shown on FIG. 2, resulting not only in increased iron loss, in precision error in determination of the rotor angle during calibration, but also in apparent accompanied cogging torque and torque ripple.

Another solution of prior art in effectively reducing harmonic content, cogging torque, and torque ripple is to eliminate harmonic content and cogging torque by means of skewed stator slots or rotor step skewing, so as to reduce torque ripple. The solution in its working principle is equivalent to multiple axially superimposed motors, with the sum of cogging torque of all the motors approaching zero and the back EMF harmonic waves cancelling each other. However, there exist the following defects:

1. Rotator skewed slot or rotor step skewing requires positioning tools for stack mounting stator lamination or rotor lamination, which will increase equipment cost and decrease production efficiency.

2. Stators for the rotator skewed slot solution become more difficult to roll off the assembly line, while the effective length of the winding coils increases correspondingly, resulting in consumption of more copper wires.

3. Rotor step skewing results in a shortened distance between opposite magnetic poles of neighboring magnetic poles, leading to weakened output capacity of the motor, with a more significant reduced capacity particularly for over skewed rotors.

4. Peak torque and peak power for a same motor with complete rotator skewed slot or rotor step skewing decreases 10%, tantamount to 10% increase of magnet consumption in order to attain the original capacity. Currently, magnet for permanent magnet synchronous motors is made principally of neodymium iron boron and makes up for 50% of cost for the whole motor due to the effect of rare earth pricing, thus is sensitive for the product economic performance.

5. Number of steps≧3 for rotor step skewing does not result in a substantial reduction in cogging torque or torque ripple, that is to say, as long as the number of steps is not infinite, the effect for the rotator skewed slot cannot be obtained, with certain cogging torque unable to be reduced by means of the rotor step skewing method.

6. For an ISG with a motor of shorter axial length or less number of slots, it is difficult to realize rotator skewed slot or rotor step skewing. And further, a substantial percentage thereof is effected by end leakage flux, with cogging torque resulted therefrom being unable to be reduced effectively by either rotator skewed slot or rotor step skewing.

7. Both rotator skewed slot and rotor step skewing produce a cyclic axial force on the rotor, resulting in increased probability of failed bearing, shortened product life, and increased axial NVH.

A permanent magnet synchronous motor with rotor step skewing employed for the Nissan LEAF is shown on FIG. 3, which substantially improves back EMF waveform, reduces both cogging torque and torque ripple. However, the motor's peak capacity is wakened, and manufacturing of the rotor get more complex.

### SUMMARY OF THE INVENTION

The technical problem the present invention aims to solve is to provide a permanent magnet synchronous motor and a rotor thereof for reducing cogging torque and torque ripple in low torque area, which has a simple structure and low cost and is easy to manufacture.

To solve the aforementioned technical problem, the present invention provides a permanent magnet synchronous motor, a rotor thereof comprising an iron core in cylindrical form, with p S pole magnet plates and p N pole magnet plates arranged inside of the iron core around an axis thereof, wherein p is a positive integer, and the p S pole magnet plates and the p N pole magnet plates are alternatively aligned;

on a surface of a rotor iron core of each magnet steel plate are arranged two d axial surface grooves;

the two d axial surface grooves corresponding to each magnet steel plate are situated on two sides of a center line of the magnet steel plate;

an inter-axial distance of the two d axial surface grooves of each magnet steel plates is 90% to 110% of a tooth tip span of a stator tooth of the permanent magnet synchronous motor.

Preferably, the permanent magnet synchronous motor is a fractional slot motor.

Preferably, an internal hole is arranged internally along the axis of the iron core in-between a pair of the S pole magnet plate and the corresponding adjacent N pole magnet plate.

Preferably, the permanent magnet synchronous motor is a fractional slot concentrated winding permanent magnet synchronous motor;

a slot number per each pole and each phase is greater than or equal to ¼ and is less than or equal to ½.

Preferably, a stator of the fractional slot concentrated winding permanent magnet synchronous motor has 24 stator teeth;

around the axis of the iron core are internally arranged 8 S pole magnet plates and 8 N pole magnet plates alternatively and evenly.

Preferably, an open width of the d axial surface groove is 50% to 150% of a width of a tooth shoe of the stator tooth of the permanent magnet synchronous motor;

preferably, the inter-axial distance of the two d axial surface grooves of each magnet steel plates is 90%, 100% or 110% of the tooth tip span of the stator tooth of the permanent magnet synchronous motor.

Preferably, the d axial surface groove is in a minor arc shape.

To solve the aforementioned technical problem, the present invention further provides a rotor of a permanent magnet synchronous motor, comprising an iron core in cylindrical form, with p S pole magnet plates and p N pole magnet plates arranged inside of the iron core around an axis thereof, wherein p is a positive integer, and the p S pole magnet plates and the p N pole magnet plates are alternatively aligned; wherein

on a surface of the rotor iron core of each magnet steel plate are arranged two d axial surface grooves;

the two d axial surface grooves corresponding to each magnet steel plate are situated on two sides of a center line of the magnet steel plate;

an inter-axial distance of the two d axial surface grooves of each magnet steel plates is 90% to 110% of a width of a tooth tip span of a stator tooth of the permanent magnet synchronous motor.

Preferably, the permanent magnet synchronous motor is a fractional slot motor.

Preferably, a q axial surface groove is arranged on an outer surface along the axis of the iron core in the middle in-between the pair of the adjacent S pole magnet plate and the N pole magnet plate.

Preferably, an internal hole is arranged internally along the axis of the iron core in-between the pair of the S pole magnet plate and the corresponding adjacent N pole magnet plate.

Preferably, the permanent magnet synchronous motor is a fractional slot concentrated winding permanent magnet synchronous motor;

a slot number per each pole and each phase is greater than or equal to ¼ and is less than or equal to ½.

Preferably, a stator of the fractional slot concentrated winding permanent magnet synchronous motor has 24 stator teeth;

around the axis of the iron core are internally arranged 8 S pole magnet plates and 8 N pole magnet plates alternatively and evenly.

Preferably, an open width of the d axial surface groove is 50% to 150% of a width of a tooth shoe of the stator tooth of the permanent magnet synchronous motor;

preferably, a depth of the d axial surface groove is 20% to 80% of an air gap;

preferably, the inter-axial distance of the two d axial surface grooves of each magnet steel plates is 90%, 100% or 110% of the width of the tooth tip span of the stator tooth of the permanent magnet synchronous motor.

Preferably, the d axial surface groove is in a minor arc shape.

The permanent magnet synchronous motor of the present invention increases fundamental component percentage in a cycle of air gap flux density, reduces back EMF harmonic content in the flux density waveform, that is to say, the air gap flux density has a low sinusoidal distortion. The magnetic field of the motor without power supply is provided solely by the magnet steel plates with the torque generated by the rotor being related only to the flux density magnitude and the magnetic permeability, thus cogging torque is diminished if the flux density waveform is sinusoidal in a linear condition. The permanent magnet synchronous motor of the present invention reduces cogging torque resulting from air gap flux density waveform distortion due to stator slotting, thus reduces level of torque ripple of the motor under load, particularly for the torque ripple in a low torque area. Moreover, the permanent magnet synchronous motor of the present invention has a simple rotor structure and low cost, and is easy to manufacture.

### BRIEF DESCRIPTION OF THE DRAWINGS

The drawings the present invention depends on are hereunder briefly described in order to clearly expound on the technical solution of the present invention. The drawings hereunder described are exemplary only of a few of the embodiments of the present invention, based upon which a person of the art is able to deduce other drawings without creative work.

FIG. 1 is a schematic diagram of a permanent magnet synchronous motor of prior art with 48 slots and 8 poles;

FIG. 2 is a schematic diagram of the back EMF waveform of the permanent magnet synchronous motor shown on FIG. 1;

FIG. 3 is a schematic diagram of a permanent magnet synchronous motor of prior art with a step skewing rotor;

FIG. 4 is a schematic diagram of a first embodiment of the rotor of the permanent magnet synchronous motor of the present invention;

FIG. 5 is a schematic diagram of a second embodiment of the rotor of the permanent magnet synchronous motor of the present invention;

FIG. 6 is a schematic diagram of a third embodiment of the rotor of the permanent magnet synchronous motor of the present invention;

FIG. 7 depicts a width of a tooth shoe and an air gap;

FIG. 8A is a schematic diagram of the back EMF of a permanent magnet synchronous motor with an untreated rotor;

FIG. 8B is a schematic diagram of the cogging torque of a permanent magnet synchronous motor with an untreated rotor;

FIG. 8C is a schematic diagram of the torque ripple of a permanent magnet synchronous motor with an untreated rotor;

FIG. 9A is a schematic diagram of the back EMF of a permanent magnet synchronous motor with a q axial surface groove and a q axial internal hole arranged on the rotor iron core thereof;

FIG. 9B is a schematic diagram of the cogging torque of a permanent magnet synchronous motor with a q axial surface groove and a q axial internal hole arranged on the rotor iron core thereof;

FIG. 9C is a schematic diagram of the torque ripple of a permanent magnet synchronous motor with a q axial surface groove and a q axial internal hole arranged on the rotor iron core thereof;

FIG. 10A is a schematic diagram of the back EMF of a permanent magnet synchronous motor with a q axial surface groove and a d axial surface groove arranged on the rotor iron core thereof;

FIG. 10B is a schematic diagram of the cogging torque of a permanent magnet synchronous motor with a q axial surface groove and a d axial surface groove arranged on the rotor iron core thereof;

FIG. 10C is a schematic diagram of the torque ripple of a permanent magnet synchronous motor with a q axial surface groove and a d axial surface groove arranged on the rotor iron core thereof;

FIG. 11A is a schematic diagram of the back EMF of a permanent magnet synchronous motor with a q axial surface groove, a q axial internal hole, and a d axial surface groove arranged on the rotor iron core thereof;

FIG. 11B is a schematic diagram of the cogging torque of a permanent magnet synchronous motor with a q axial surface groove, a q axial internal hole, and a d axial surface groove arranged on the rotor iron core thereof;

FIG. 11C is a schematic diagram of the torque ripple of a permanent magnet synchronous motor with a q axial surface groove, a q axial internal hole, and a d axial surface groove arranged on the rotor iron core thereof; and

FIG. 12 is a schematic diagram showing air gap flux density magnitude respectively with and without a q axial surface groove.

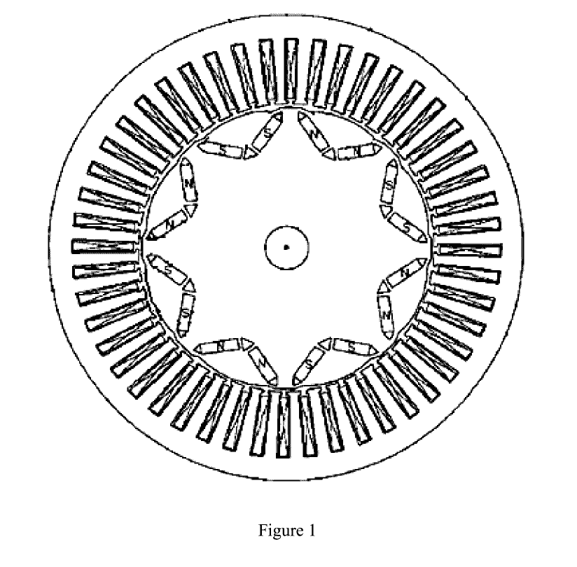

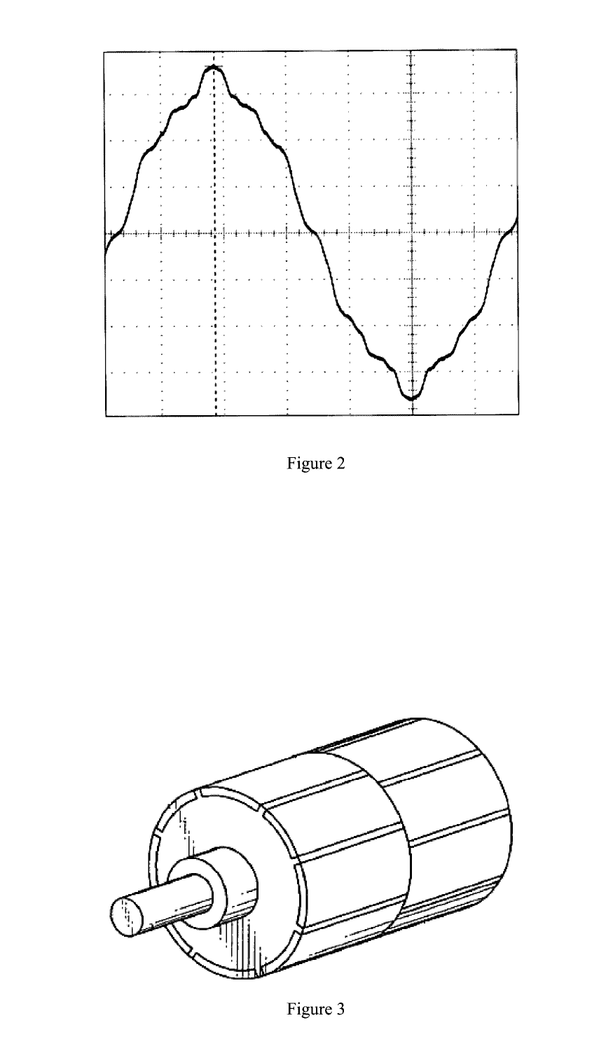

### DETAILED DESCRIPTION

In combination with the drawings hereunder provided, the technical solution of the present invention will be clearly described in its entirety, albeit apparently the described embodiments are only part and not all of the possible embodiments of the present invention. Based on the embodiments of the present invention, a person of the art is able to deduce other embodiments without creative work, which shall fall within the scope of protection of the present invention.

### Embodiment One

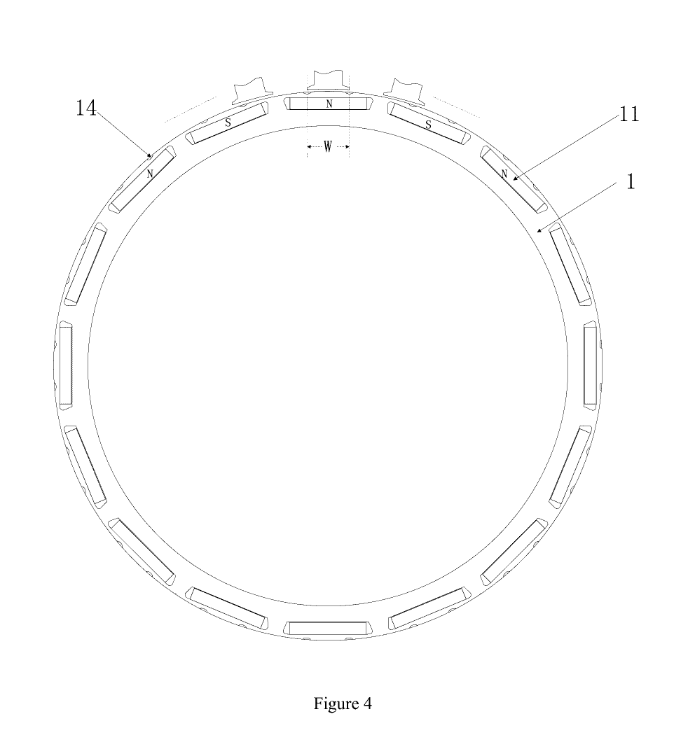

A permanent magnet synchronous motor, a rotor thereof is shown on FIG. 4, comprises an iron core 1;

The iron core 1 is in cylindrical form, with p S pole magnet plates 11 and p N pole magnet plates 11 arranged inside of the iron core around an axis thereof, wherein p is a positive integer, and the p S pole magnet plates and the p N pole magnet plates are alternatively aligned;

on a surface of a rotor iron core of each magnet steel plate are arranged two d axial surface grooves 14;

the two d axial surface grooves 14 corresponding to each magnet steel plate are situated on two sides of a center line (that is, a d axis) of the magnet steel plate;

an inter-axial distance of the two d axial surface grooves 14 of each magnet steel plates is approximately equal to a tooth tip span w of the stator tooth of the permanent magnet synchronous motor (for example 90% to 110% of the tooth tip span w of the stator tooth of the permanent magnet synchronous motor, and can be 90%, 100%, or 110% of the tooth tip span w of the stator tooth of the permanent magnet synchronous motor).

Cogging torque results from a tangential component of an uneven interacting force between a permanent magnet body of the permanent magnet synchronous motor and the stator teeth of a slotted stator. The cogging torque T_{cog}, ignoring saturation effect of the iron core, is represented as

$${T}_{cog} = \frac{π {ZL}_{a}}{4 {μ}_{0}} \cdot ( {R}_{2}^{2} - {R}_{1}^{2} ) {\sum }_{n = 1}^{∞} {nG}_{n} {B}_{r \frac{nZ}{2 p}} sin nZ α ,$$

wherein Z is the number of the stator teeth, Lₐ is an axial length of the iron core, μ₀ is a constant, R₁ is an inner diameter of the corresponding air gap, R₂ is an outer diameter of the corresponding air gap, Gₙ is a coefficient for the corresponding air gap permeance, Br is magnetic flux density generated by the permanent magnet along a circumference of the air gap, α is an angle between the center line (d axis) of the permanent magnet body and a center line of the stator tooth, n is a positive integer such that nZ/2p is an integer. As can be inferred from the above expression, only a magnetic flux density component with nZ/2p order can generate cogging torque, and so it is possible to reduce cogging torque by means of reducing the magnitude of the magnetic flux density Br with order nZ/2p.

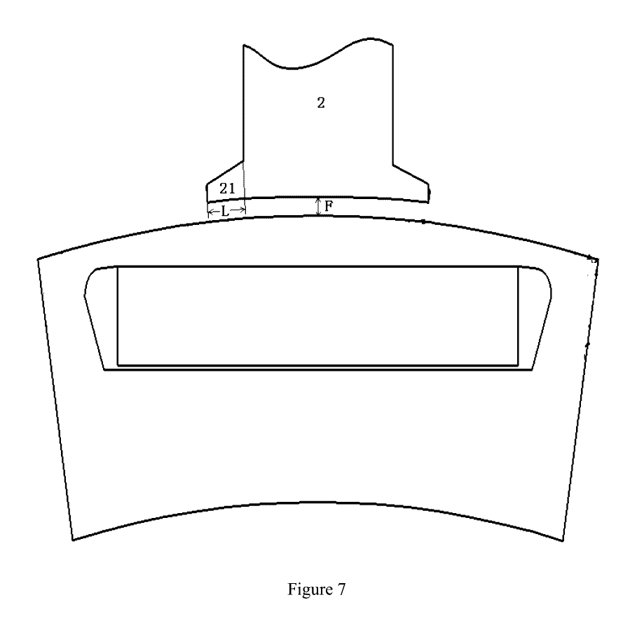

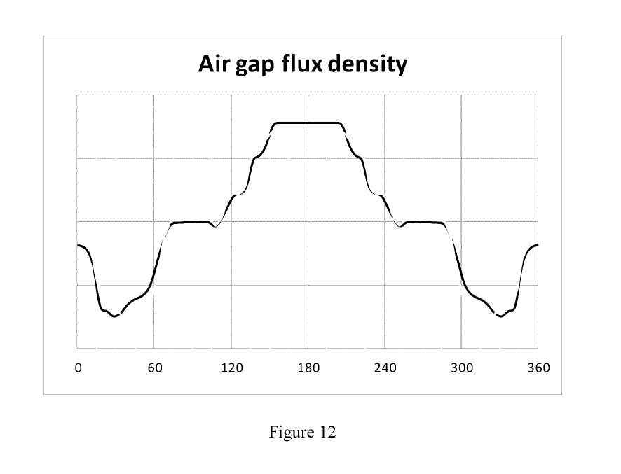

For the permanent magnet synchronous motor of embodiment one, on the surface of the rotor iron core of each magnet steel plate are arranged two d axial surface grooves 14, wherein the inter-axial distance of the two d axial surface grooves 14 of each magnet steel plates is approximately equal to the tooth tip span w of the stator tooth of the permanent magnet synchronous motor. As such, and as are shown on FIG. 4 and FIG. 7, in the case the center line of the stator tooth agrees with the d axis, the axial line of the two d axial surface grooves corresponding to each magnet steel plate is located on a shoe tip of the tooth shoe 21 of the stator tooth, thus a drastic change of the air gap flux density magnitude is prevented, reducing magnitude of the flux density back EMF harmonic waveform, and according to a theoretical analysis of the cogging torque expression, the cogging torque will reduce correspondingly. As is shown on FIG. 12 (wherein the light color curve line and the deep color curve line respectively correspond to the pre-slotting and post-slotting air gap flux density), magnitude of the low-order harmonic in the back EMF is drastically reduced.

The permanent magnet synchronous motor of embodiment one increases fundamental component percentage in a cycle of air gap flux density, reduces back EMF harmonic content in the flux density waveform, that is to say, the air gap flux density has a low sinusoidal distortion. The magnetic field of the motor without power supply is provided solely by the magnet steel plates with the torque generated by the rotor being related only to the flux density magnitude and the magnetic permeability, thus cogging torque is diminished if the flux density waveform is sinusoidal in a linear condition. The permanent magnet synchronous motor of embodiment one reduces cogging torque resulting from air gap flux density waveform distortion due to stator slotting, thus reducing level of torque ripple of the motor under load. Since cogging torque represents a large percentage of torque ripple in a low torque area, torque ripple is drastically reduced if cogging torque is low. Moreover, the permanent magnet synchronous motor of embodiment one has a simple rotor structure and low cost, and is easy to manufacture.

Preferably, as is shown on FIG. 7, the open width of the d axial surface groove 14 is 50% to 150% (for example, 50%, 100%, or 150%) of the width L of the tooth shoe 21 of the stator tooth 2 of the permanent magnet synchronous motor, the depth of the d axial surface groove 14 is 20% to 80% (for example, 20%, 50%, or 80%) of the air gap F. As is mentioned previously, the air gap flux density comprises a constant component, a fundamental component, and a harmonic component, with the fundamental component solely contributing to the performance of the motor. An even change in air gap results in a larger fundamental component of the air gap flux density, while the open width of the d axial surface groove 14 between 50% to 150% of the width L of the tooth shoe 21 of the stator tooth 2 of the permanent magnet synchronous motor and the depth of the d axial surface groove 14 between 20% to 80% of the air gap F result in an even change of air gap flux density from the d axis to the q axis, and thus harmonic effect due to slotting of the d axial surface grooves 14 is reduced.

Preferably, the d axial surface groove 14 is in a minor arc shape. The d axial surface grooves 14 in a minor arc shape will further mitigate drastic change of the air gap flux density due to stator slotting, thus reducing drastic change in air gap flux density magnitude. Further, such axial surface grooves affect mechanical strength of the rotor in a minor manner, and thus the rotor is easier to manufacture.

### Embodiment Two

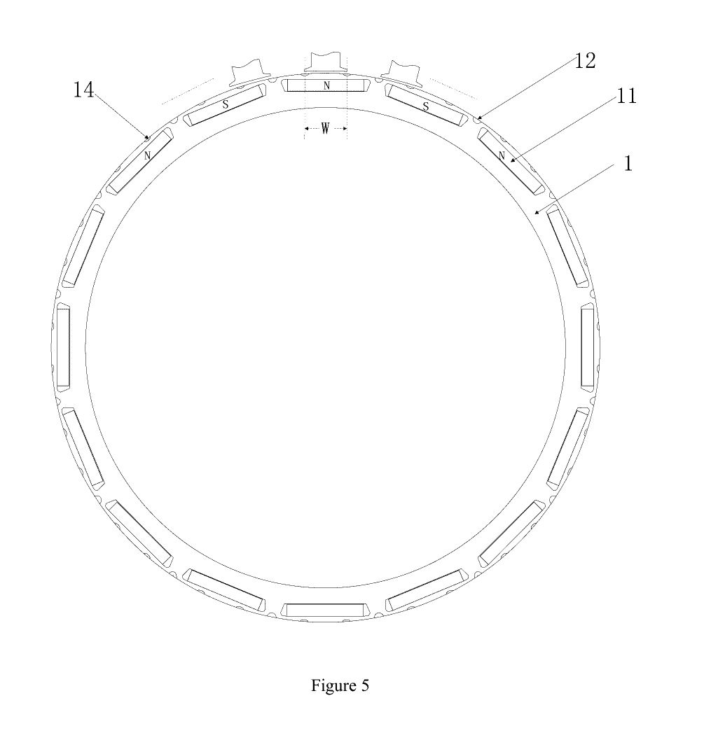

Embodiment two is based on the permanent magnet synchronous motor of embodiment one, the permanent magnet synchronous motor being a fractional slot motor, as is shown on FIG. 5, with a q axial surface groove 12 being arranged on an outer surface along the axis of the iron core in the middle (that is, the locus of the q axis) in-between the pair of the adjacent S pole magnet plate and the N pole magnet plate.

The average torque of a permanent magnet synchronous motor is T=p[φ_{f}i_{q}+(L_{d}−L_{q})i_{d}i_{q}], wherein p is a number of pole pairs of the motor, φ_{f} is flux generated by a fundamental magnetic field of the permanent magnet boy on the stator coils, id is d axial current of the stator, Ld is d axial inductance of the stator winding coils, Lq is q axial inductance of the stator winding coils. The torque T of the permanent magnet synchronous motor is constituted principally of two parts, a synchronous torque generated by the permanent magnet flux (caused by excitation magnetic field of the permanent magnet material and the d axial current), and a reluctance torque induced by inequality between the d axial inductance Ld and the q axial inductance Lq due to asymmetry of a d axial magnetic circuit with a q axial magnetic circuit, with the reluctance torque being capable of increasing the torque/current density of the permanent magnet motor on one hand and substantially increasing torque ripple on the other hand.

As for a fractional slot motor (that is, a motor whose slot number per pole per phase is a fraction

$$T = \frac{Z}{2 pm} = b + \frac{j}{k} ,$$

wherein p is a number of pole pairs of the motor, m is a number of phase, Z is a number of stator teeth, b, j, and k are positive integers, with K>j), the reluctance torque induced by inequality between the d axial inductance Ld and the q axial inductance Lq due to asymmetry of a d axial magnetic circuit with a q axial magnetic circuit only constitutes a small percentage, it is generally possible to substantially reduce the torque ripple by means of altering the shape of the q axial magnetic circuit, with a total torque unchanged.

Slotting on the surface of the d axis reduces cogging torque and torque ripple in the low torque area, while in the high torque area, the corresponding current is comparatively large, and thus torque ripple due to reluctance torque constitutes a large percentage. Therefore, slotting on the q axis, via changing the parameter Lq, substantially improves torque ripple in the medium and high torque areas under an operating load. The permanent magnet synchronous motor of embodiment two is a fractional slot motor with d axial surface grooves and q axial surface grooves arranged on the surface of the rotor iron core. It not only reduces cogging torque caused by distortion of air gap flux density waveform due to stator slotting and torque ripple in the low torque area, but also substantially reduces torque ripple of the motor under the operating load, particularly that in the medium and high torque area, with the total torque basically unchanged, by means of changing the shape of the q axial magnetic circuit via slotting on the locus of the q axis on the rotor iron core surface.

Preferably, the permanent magnet synchronous motor is a fractional slot concentrated winding permanent magnet synchronous motor, with a slot number per pole per phase greater than or equal to ¼ and less than or equal to ½. Concentrated winding features advantages of a shortened end connection, reduced wire consumption, lower resistance of winding coils, reduced copper consumption, elevated motor efficiency, reduced cost, and shortened manufacturing cycle. Since a fractional slot concentrated winding permanent magnet synchronous motor has a winding pitch y=1, when Z/p falls within 3/2 and 3, that is, the slot number per pole per phase is greater than or equal to ¼ and less than or equal to ½, the two coil side induced electromotive forces of a same coil differ by approximately 180°, and a comparatively higher winding coefficient is obtained.

Preferably, the stator of the fractional slot concentrated winding permanent magnet synchronous motor has 24 stator teeth (Z=24), with only one coil wound around each stator tooth; around the axis of the iron core are internally arranged 8 S pole magnet plates and 8 N pole magnet plates alternatively and evenly (8 pairs of rotor magnetic poles, p=8, altogether 2p poles), and thus the slot number per pole per phase is

$$T = \frac{Z}{2 pm} = \frac{24}{2 * 8 * 3} = \frac{1}{2} .$$

### Embodiment Three

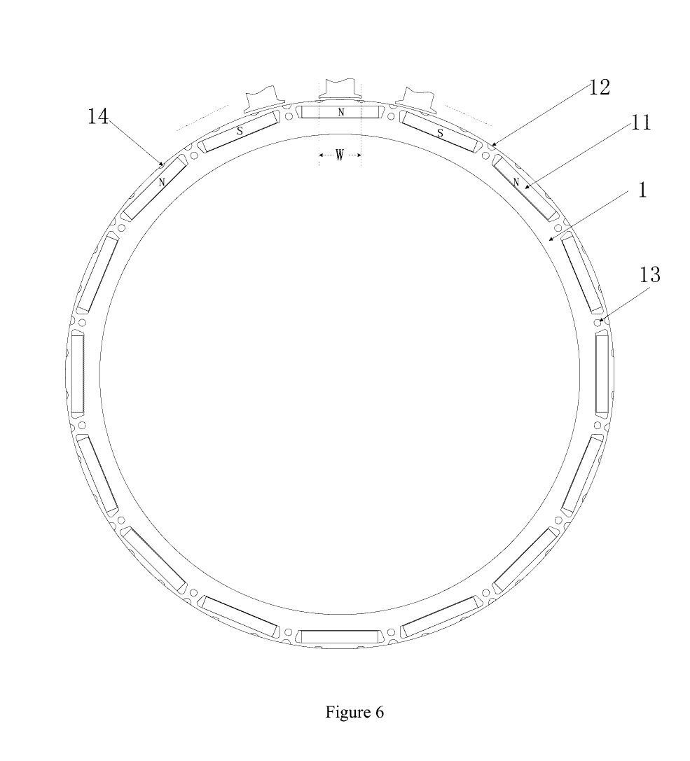

Embodiment three is based on the permanent magnet synchronous motor of embodiment two, as is shown on FIG. 6, with an internal hole 13 further arranged at the middle (that is, the locus of the q axis) in-between the adjacent S pole magnet steel plate and the N pole magnet steel plate of the iron core 1 internally along the axis thereof.

Slotting on the surface of the d axis reduces cogging torque and torque ripple in the low torque area, while in the high torque area, the corresponding current is comparatively large, and thus torque ripple due to reluctance torque constitutes a large percentage. Therefore, slotting on the q axis, via changing the parameter Lq, substantially improves torque ripple in the medium and high torque areas under an operating load.

Opening a hole internally on the q axis of the iron core not only reduces torque ripple due to saliency effect of the motor, but is also tantamount to a narrowed q axial magnetic bridge, thus increasing magnetic field saturation at the locus, decreasing pole-pole leakage, and is equivalent to increasing the flux of the permanent magnet, that is, increasing magnet steel efficiency of the motor; moreover, opening a hole on the q axis of the iron core increases magnetoresistance of the q axial magnetic circuit, and strengthens the anti-demagnetization of the magnetic steel, since a d axial flux weakening reversed field entering the magnet steel is weakened under a same stator current.

The permanent magnet synchronous motor of embodiment three, slotting on the q axis of the rotor iron core, opening a hole on the q axis of the iron core, and with two d axial surface grooves 14 arranged symmetric to the d axis on the surface of the rotor core of each magnet steel plate, reduces torque ripple due to saliency effect of the motor; it further curtails pole-pole leakage and increases magnet steel efficiency; it strengthens the anti-demagnetization of the magnetic steel, since a d axial flux weakening reversed field entering the magnet steel is weakened under a same stator current; it reduces cogging torque and torque ripple in the whole area under an operating load, and achieves effect of step skewing.

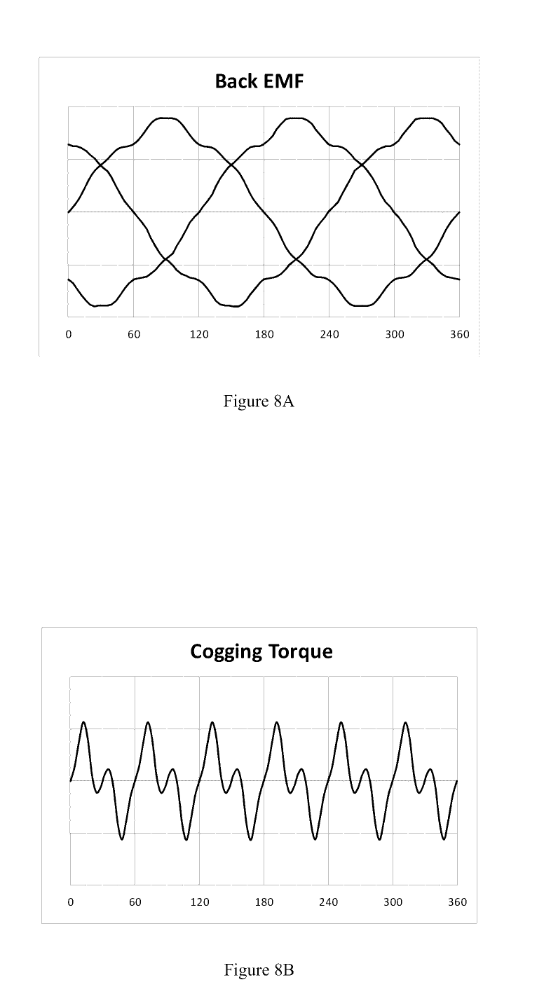

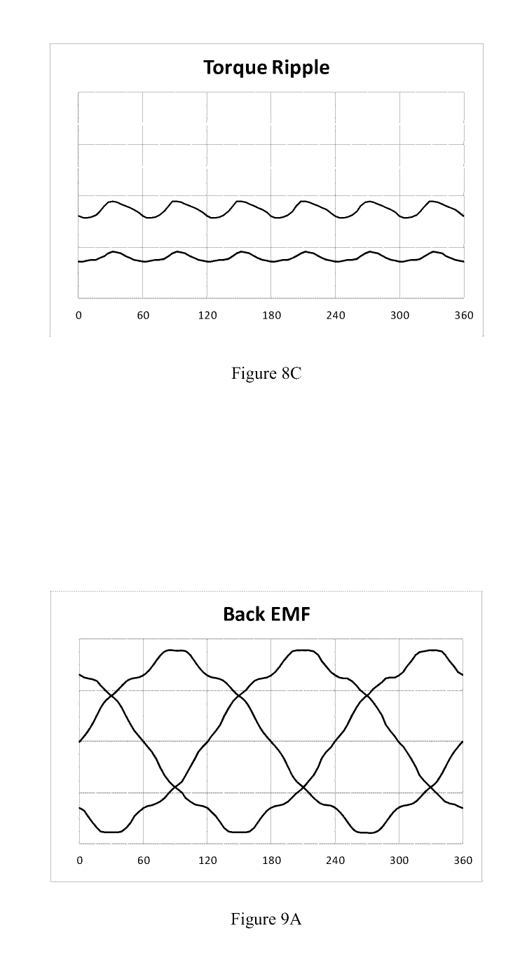

The back EMF of a permanent magnet synchronous motor with an untreated rotor is shown on FIG. 8A, the cogging torque of the permanent magnet synchronous motor with an untreated rotor is shown on FIG. 8B, and the torque ripple of the permanent magnet synchronous motor with an untreated rotor is shown on FIG. 8C.

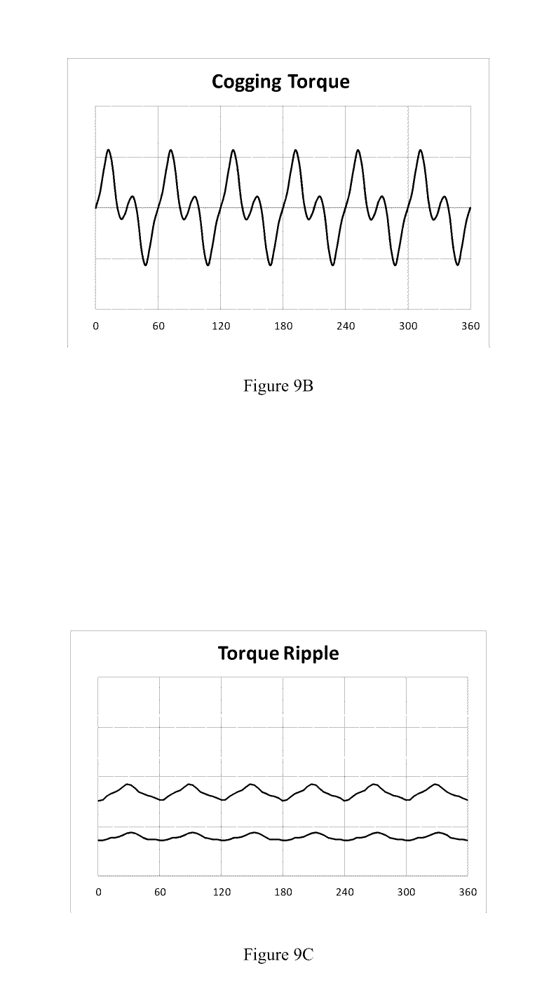

The back EMF of a permanent magnet synchronous motor with a q axial surface groove and a q axial internal hole arranged on the rotor iron core thereof is shown on FIG. 9A, the cogging torque thereof is shown on FIG. 9B, and the torque ripple thereof is shown on FIG. 9C.

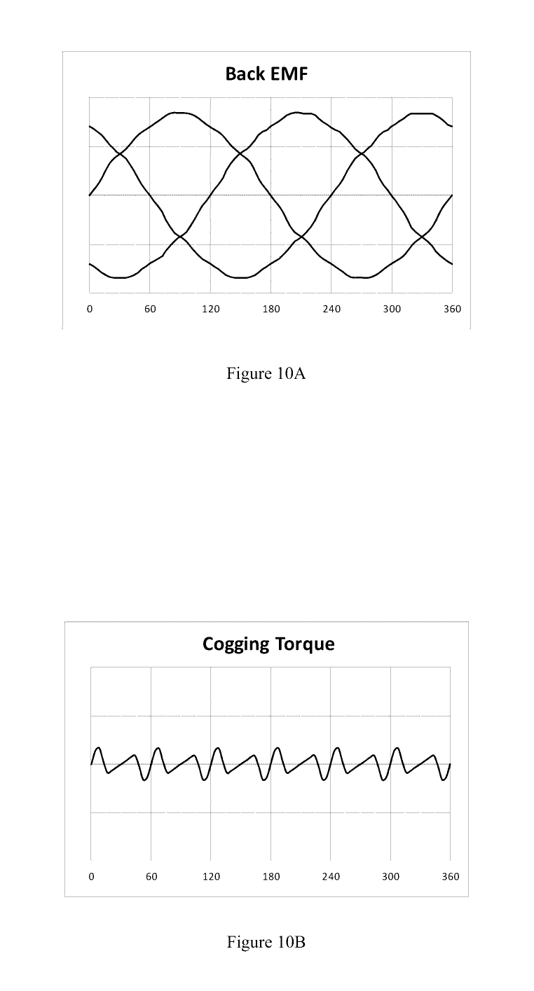

The back EMF of a permanent magnet synchronous motor with a q axial surface groove and a d axial surface groove arranged on the rotor iron core thereof is shown on FIG. 10A, the cogging torque thereof is shown on FIG. 10B, and the torque ripple thereof is shown on FIG. 10C.

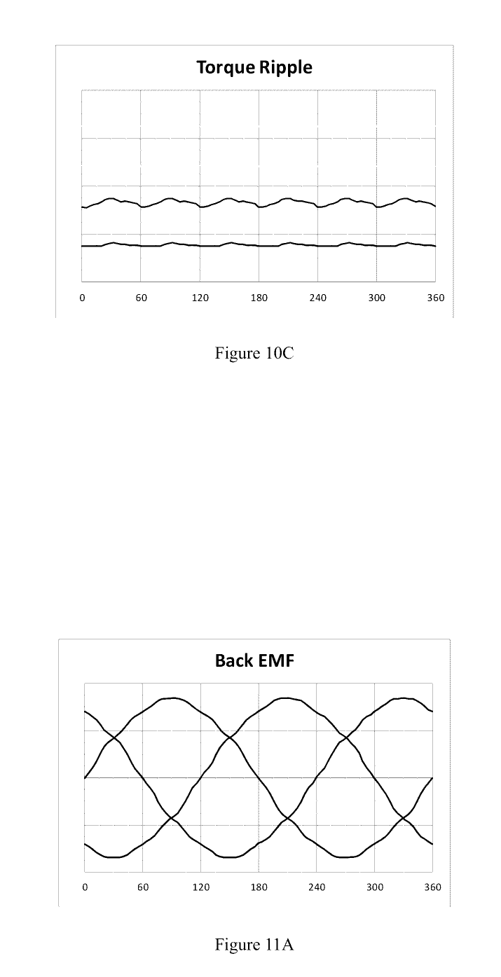

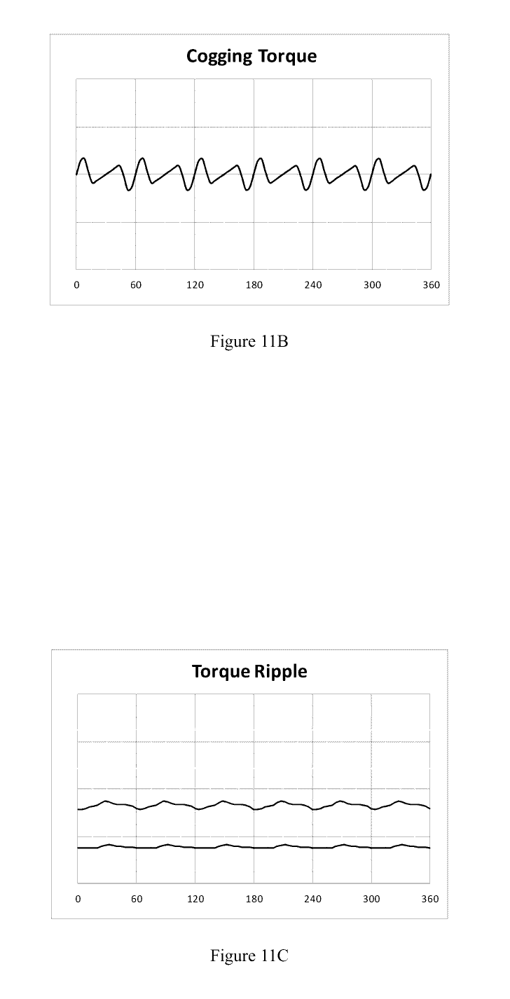

The back EMF of a permanent magnet synchronous motor with a q axial surface groove, a q axial internal hole, and a tooth shoe groove arranged on the rotor iron core thereof is shown on FIG. 11A, the cogging torque thereof is shown on FIG. 11B, and the torque ripple thereof is shown on FIG. 11C.

The foregoing embodiments are just a few of the preferred embodiments of the present invention, and are not meant to limit the present invention, modification, equivalent substitution, or improvement thereof within the spirit and principle of the present invention shall fall within the scope of protection of the present invention.

1-14. (canceled)

15. A permanent magnet synchronous motor, comprising a rotor, wherein the rotor comprises an iron core in cylindrical form, with p S pole magnet plates and p N pole magnet plates arranged inside of the iron core around an axis thereof, wherein p is a positive integer, and the p S pole magnet plates and the p N pole magnet plates are alternatively aligned; wherein:
on a surface of a rotor iron core of each magnet steel plate are arranged two d axial surface grooves;
the two d axial surface grooves corresponding to each magnet steel plate are situated on two sides of a center line of the magnet steel plate;
an inter-axial distance of the two d axial surface grooves of each magnet steel plates is 90% to 110% of a tooth tip span of a stator tooth of the permanent magnet synchronous motor.

16. The permanent magnet synchronous motor of claim 15, wherein the permanent magnet synchronous motor is a fractional slot motor, and
wherein a q axial surface groove is arranged on an outer surface along the axis of the iron core in the middle in-between the pair of the adjacent S pole magnet plate and the N pole magnet plate.

17. The permanent magnet synchronous motor of claim 15, wherein an internal hole is arranged internally along the axis of the iron core in-between each pair of the adjacent S pole magnet plate and the N pole magnet plate.

18. The permanent magnet synchronous motor of claim 17, wherein the permanent magnet synchronous motor is a fractional slot concentrated winding permanent magnet synchronous motor, a slot number per pole per phase is greater than or equal to ¼ and is less than or equal to ½.

19. The permanent magnet synchronous motor of claim 18, wherein a stator of the concentrated winding permanent magnet synchronous motor has 24 stator teeth, around the axis of the iron core are internally arranged 8 S pole magnet plates and 8 N pole magnet plates alternatively and evenly.

20. The permanent magnet synchronous motor of claim 15, wherein an open width of the d axial surface groove is 50% to 150% of a width of a tooth shoe of the stator tooth of the permanent magnet synchronous motor, a depth of the d axial surface groove is 20% to 80% of an air gap, and the inter-axial distance of the two d axial surface grooves of each magnet steel plates is 90%, 100%, or 110% of the tooth tip span of the stator tooth of the permanent magnet synchronous motor.

21. The permanent magnet synchronous motor of claim 15, wherein the d axial surface groove is in a minor arc shape.

22. A rotor of a permanent magnet synchronous motor comprising an iron core in cylindrical form, with p S pole magnet plates and p N pole magnet plates arranged inside of the iron core around an axis thereof, wherein p is a positive integer, and the p S pole magnet plates and the p N pole magnet plates are alternatively aligned; wherein:
on a surface of a rotor iron core of each magnet steel plate are arranged two d axial surface grooves;
the two d axial surface grooves corresponding to each magnet steel plate are situated on two sides of a center line of the magnet steel plate; and
an inter-axial distance of the two d axial surface grooves of each magnet steel plates is 90% to 110% of a tooth tip span of a stator tooth of the permanent magnet synchronous motor.

23. The rotor of the permanent magnet synchronous motor of claim 22, wherein the permanent magnet synchronous motor is a fractional slot motor;
wherein a q axial surface groove is arranged on an outer surface along the axis of the iron core in the middle in-between the pair of the adjacent S pole magnet plate and the N pole magnet plate.

24. The rotor of the permanent magnet synchronous motor of claim 22, wherein an internal hole is arranged internally along the axis of the iron core in-between each pair of the adjacent S pole magnet plate and the N pole magnet plate.

25. The rotor of the permanent magnet synchronous motor of claim 24, wherein the permanent magnet synchronous motor is a fractional slot concentrated winding permanent magnet synchronous motor, a slot number per pole per phase is greater than or equal to ¼ and is less than or equal to ½.

26. The rotor of the permanent magnet synchronous motor of claim 25, wherein a stator of the fractional slot concentrated winding permanent magnet synchronous motor has 24 stator teeth, and around the axis of the iron core are internally arranged 8 S pole magnet plates and 8 N pole magnet plates alternatively and evenly.

27. The rotor of the permanent magnet synchronous motor of claim 22, wherein an open width of the d axial surface groove is 50% to 150% of a width of a tooth shoe of the stator tooth of the permanent magnet synchronous motor, a depth of the d axial surface groove is 20% to 80% of an air gap, and the inter-axial distance of the two d axial surface grooves of each magnet steel plates is 90%, 100%, or 110% of the tooth tip span of the stator tooth of the permanent magnet synchronous motor.

28. The permanent magnet synchronous motor of claim 22, wherein the d axial surface groove is in a minor arc shape.
